(19) United States
(12) Patent Application Publication
(10) Pub. No.: US 2004/0168535 A1
(43) Pub. Date: Sep. 2, 2004

(54) Window lifter geared motor assembly

(76) Inventor: Gerard Fournier, Ifs (FR)

Correspondence Address: CARLSON, GASKEY & OLDS, P.C., 400 WEST MAPLE ROAD, SUITE 350, BIRMINGHAM, MI, 48009, US

(21) Appl. No.: 10/627,202

(22) Filed: Jul. 25, 2003

(30) Foreign Application Priority Data
Jul. 30, 2002 (FR) FR 02 09 684

(51) Int. Cl. F16H 1/16

(52) U.S. Cl. 74/425

(57) ABSTRACT

A window lifter geared motor assembly includes a housing, an electric motor in the housing, a damper damping the movements of the electric motor in the housing, and a drive shaft driven in rotation about an axis by the electric motor. The electric motor and the drive shaft are able to move in the housing along the axis, and the damper damps the movements of the electric motor and the drive shaft along the axis. The assembly further includes a sensor, the state of which is dependent upon the movements of the electric motor and of the drive shaft along the axis. The driving of the drive shaft is preferably dependent upon the state of the sensor and the drive shaft is stopped when an obstacle impedes movement of the window. The damper occupies a position that is immobile with respect to the housing, allowing the damper not to experience movements likely to cause the characteristics of the damper to vary.

This application claims priority to French patent application No. 02 09 684 filed on Jul. 30, 2002.

### BACKGROUND OF THE INVENTION

The present invention relates generally to a window lifter geared motor assembly including a damper that damps movements of an electric motor in a housing of the geared motor assembly.

Numerous equipment items in motor vehicles are operated using a geared motor assembly. For example, the rear-view mirrors, the window lifter windows or the sunroof are often driven by geared motor assemblies. However, it is possible for an object to impede the movement of the equipment, possibly causing blocking and damage to the geared motor assembly.

A geared motor assembly including a reduction gearset driven in rotation by an electric motor has been protected by a rubber damper in the reduction gearset. However, as the damper is driven in rotation by the reduction gearset, the damper experiences variations in temperature. Therefore, the characteristics of the damper can vary during use of the geared motor assembly, decreasing the quality of the protection afforded to the geared motor assembly in the event of blockage.

Therefore, there is a need for a geared motor assembly that is protected reliably in the event of blocking of the geared motor assembly.

### SUMMARY OF THE INVENTION

The invention provides a window lifter geared motor assembly including a housing, an electric motor in the housing, and a damper that damps the movements of the electric motor in the housing.

The geared motor assembly further includes a drive shaft driven in rotation about an axis by the electric motor. The electric motor and the drive shaft are able to move in the housing along the axis, and the damper damps the movements of the electric motor and the drive shaft along the axis.

In one embodiment, the damper damps the movements of the electric motor in one direction along the axis. In this embodiment, the damper includes a spring positioned between the housing and the electric motor. In another embodiment, the damper damps the movements of the electric motor in both directions along the axis. In this embodiment, the damper includes two tension-compression springs positioned between the housing and the electric motor, one spring positioned on each side of the electric motor along the axis.

In another embodiment, the geared motor assembly further includes a sensor. The state of the sensor changes depending upon the movement of the electric motor and the drive shaft along the axis. Preferably, the drive shaft is guided with respect to the sensor by a bearing on which the sensor is located.

According to another embodiment, the reduction gearset is driven in rotation about a reduction shaft guided with respect to the housing by a bearing on which the sensor is placed. Alternately, the sensor may be fixed with respect to the housing. Preferably, the driving of the drive shaft is a function of the state of the sensor.

The invention also relates to a window lifter including a geared motor assembly as described hereinabove.

Other features and advantages of the invention will become apparent from reading the detailed description which follows of some embodiments of the invention given solely by way of example and with reference to the drawings.

### BRIEF DESCRIPTION OF THE DRAWINGS

FIG. 1 illustrates a cross-sectional view of the geared motor assembly of the present invention;

FIG. 2 illustrates a top view of the geared motor assembly; and

FIG. 3 illustrates a front view of the geared motor assembly.

### DESCRIPTION OF THE PREFERRED EMBODIMENT

The invention relates to a geared motor assembly 1 including a housing 2 in which an electric motor 3 and a damper 4 that damps the movements of the electric motor 3 are located. The damper 4 provides the function of damping the relative movement of two elements that are not rotationally driven. The mechanical properties of the damper 4 do not vary because of torsional deformation. This allows the geared motor assembly 1 to be reliably protected in the event of it blocking.

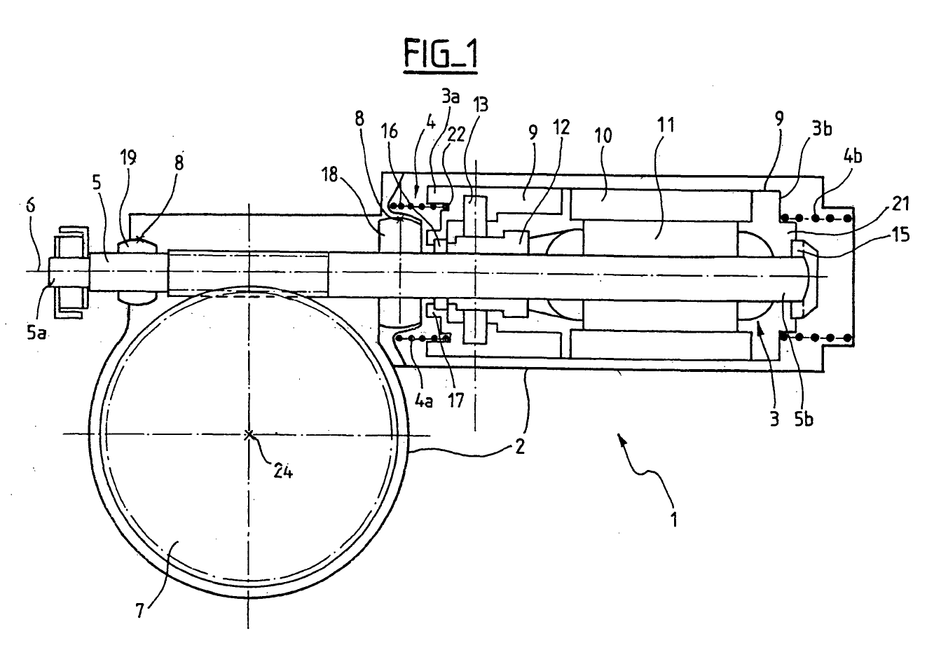

FIG. 1 shows a cross-sectional view of the geared motor assembly 1 including a housing 2 and the electric motor 3, both within the housing 2. Damper 4 is positioned between the housing 2 and the electric motor 3 and dampens movements of the electric motor 3 in the housing 2. The damper 4 is arranged between two components of the geared motor assembly 1 which are not rotationally driven. The damper 4 occupies an immobile position with respect to the housing 2, such that the damper 4 does not experience movements, other than those associated with its damping function, that are likely to cause a variation in its mechanical properties. The position of the damper 4 allows it to be more temperature-stable than it would be if it were rotationally driven. Therefore, the damper 4 does not experience temperature variations detrimental to its mechanical properties.

The electric motor 3 includes a stator 10 and a rotor 11 inside a casing 9. The damper 4 is urged against the casing 9 which does not have its own translational or rotational movement imparted to it. The casing 9, in contrast, experiences movements, such as vibrations, due to the operation of the electric motor 3. The casing 9 also experiences translational movements if the geared motor assembly 1 becomes blocked. As known, the rotor 11 includes windings wound around stacked laminations. A communator 12 is electrically connected to the rotor 11 and, via brushes 13, receives the current powering the electric motor 3.

The geared motor assembly 1 further includes a drive shaft 5 that is rotationally driven about an axis 6 by the electric motor 3. The drive shaft 5 includes ends 5a and 5b. The drive shaft 5 is connected by one of the ends 5b in the casing 9 to the rotor 11. The end 5a of the shaft 5 extends out of the casing 9. The end 5b of the drive shaft 5 is guided with respect to the casing 9 by a bearing 15. The drive shaft 5 includes a shoulder 16 which bears against a flange 17 of the casing 9. The drive shaft 5 is restrained in terms of translation along its axis 6 with respect to the casing 9 by the bearing 15 and by the collaboration between the flange 17 and the shoulder 16. The drive shaft 5 is secured to the electric motor 3. The drive shaft 5 and the electric motor 3 are mounted so that they can move in the housing 2, that is, there is some axial assembly play along the axis 6 in the housing 2.

The drive shaft 5 rotationally drives the reduction gearset 7. The reduction gearset 7 is connected to an output, such as the winding drum of the window lifter cable (not illustrated). In this embodiment, the connection between the reduction gearset 7 and the drive shaft 5 is a worm and wheel connection. The drive shaft 5 has a screw thread on its part outside the casing 9. The reduction gearset 7 is a gearwheel that meshes with the thread on the drive shaft 5. Rotation of the electric motor 3 in one direction or the other would thus cause the window to move up or down.

When the electric motor 3 is actuated to move the window up or down, an object may impede the movement of the window. The reduction gearset 7 connected to the window via the drum, the cable and the slider (not illustrated) are then blocked in its rotational movement. As the rotational drive of the drive shaft 5 by the electric motor 3 is not interrupted, the drive shaft 5 experiences a sudden translational movement along its axis 6. The direction of movement of the drive shaft 5 along its axis 6 depends on the direction in which the electric motor 3 is turning. As the drive shaft 5 is secured to the electric motor 3, the electric motor 3 experiences movement along the axis 6. As the inertia of the electric motor 3 is greater than that of the drive shaft 5, it is particularly advantageous to damp the movements of the drive shaft 5 by damping the movements of the electric motor 3 in the housing 2 using the damper 4. Damping the movements of the electric motor 3 protects the worm and wheel connection between the drive shaft 5 and the reduction gearset 7

Damping the movements of the electric motor 3 in the housing 2 also avoids the rattling that occurs in the geared motor assembly 1 upon startup. When the drive shaft 5 is started up, the drive shaft 5 bears against the still, immobile reduction gearset 7 and experiences translation along its axis 6. The drive shaft 5, secured to the electric motor 3, then via one end 5a, 5b comes into abutment against the housing 2, generating a rattling noise. The damping of the movement of the electric motor 3 in the housing 2 avoids this noise and protects the window lifter against wear.

Damping the movements of the electric motor 3 in the housing 2 also makes it possible to damp the movement of the window at the end of its travel in the door. When the window has been fully lowered or raised, it is then blocked. The damper 4 then affords the same advantages as it does when the window is impeded by an obstacle in its movement.

In one example, the damper 4 damps the movements of the electric motor 3 in one direction along the axis 6. In FIG. 1, the damper 4 has a damper 4b arranged between one end 3b of the electric motor 3 and the housing 2 (to the right in FIG. 1). Depending on the direction of rotation of the electric motor 3 and when one of the phenomena already described arises, the damper 4 damps the movement of the electric motor 3 from left to right in FIG. 1. The damper 4 prevents the electric motor 3 from coming into contact with the housing 2 and protects the gearing between the drive shaft 5 and the reduction gearset 7.

Alternatively, the damper 4 damps the movements of the electric motor 3 in the other direction along the axis 6. In FIG. 1, a damper 4a is arranged between the other end 3a of the electric motor 3 and the housing 2 (to the left in FIG. 1). The advantages described in the above paragraph are repeated.

Preferably, the damper 4 thus dampens the movement of the electric motor 4 in both directions along the axis 6. The damper 4 is arranged between the two ends 3a and 3b of the electric motor 3. This makes it possible to damp movements of the electric motor 3 in either direction the electric motor 3 is turning. The presence of the damper 4 along the axis 6 allows the damper 4 to be stressed in compression and in tension.

Preferably, the dampers 4a and 4b are springs. The springs are positioned more readily at the end 3a or 3b of the electric motor 3. In particular, the spring is more readily positioned at the end 3a of the electric motor 3 where the drive shaft 5 projects from the casing 9. The spring is positioned between the housing 2 and the end 3a of the motor 3 and surround the drive shaft 5. The spring is held on the casing 9 of the electric motor 3 by structures on the casing 9 that guide the drive shaft 5. At the end 3a of the electric motor 3, the spring 4a is held in a groove 22 around the flange 17. At the end 3b of the electric motor 3, the spring 4b is arranged on a shoulder 21 provided to hold the bearing 15. If it is desired for the electric motor 3 to be damped in both directions along the axis 6, the damper 4 includes the two springs 4a, 4b between the housing 2 and the electric motor 3, one on each side of the electric motor 3 along the axis 6. In one example, the springs have a spring rate of 60 N/mm.

Preferably, the geared motor assembly 1 further includes a sensor 8 which allows operation of the geared motor assembly 1 to be interrupted when the reduction gearset 7 is blocked, improving the protection of the gearing between the drive shaft 5 and the reduction gearset 7. The driving of the drive shaft 5 is dependent upon the state of the sensor 8. Therefore, the sensor 8 allows operation of the geared motor assembly 1 to be interrupted when the movement of the window of the window lifter is impeded by an obstruction. The sensor 8 thus makes it possible to avoid trapping of the obstruction. For unambiguous detection of the blocking of the window on the part of the sensor 8, it is preferable for the driveline between the obstacle on the window and the sensor 8 to be “rigid.” In a window lifter, the “driveline” is to be understood to mean the sequence including the window, the slider on the window, the cable, the drum, the reduction gearset 7, the drive shaft and the electric motor 3. As the damper 4 interrupts this rigidity, it is therefore not desirable for the damper 4 to lie between the sensor 8 and the obstacle.

Because the damper 4 is situated at the end of the driveline between the motor 3 and the housing 2, there are numerous points in the geared motor assembly 1 at which the sensor 8 can be positioned along the driveline.

Preferably, the sensor 8 is fixed with respect to the housing 2 facilitating the connection of the terminals of the sensor 8 to the sensor state processing circuit (not depicted). The expression “fixed” is to be understood as meaning that the sensor 8 is not driven in a rotational or translational movement by the part supporting it. The presence of a damper 4 between the housing 2 and the electric motor 3 offers various locations at which the sensor 8 can be fixed with respect to the housing 2.

According to one example, the state of the sensor 8 is dependent upon the movements of the electric motor 3 and the drive shaft 5 along the axis 6. When the reduction gearset 7 is blocked in its rotation via an obstacle impeding the movement of the window, the electric motor 3 and the drive shaft 5 experience a movement along the axis 6. The sensor 8 is able to detect this translational movement.

In FIG. 1, the sensor 8 is placed on one of the bearings 18, 19 that guide the drive shaft 5. Translational movement of the drive shaft 5 is detected by the sensor 8 which is fixed with respect to the housing 2.

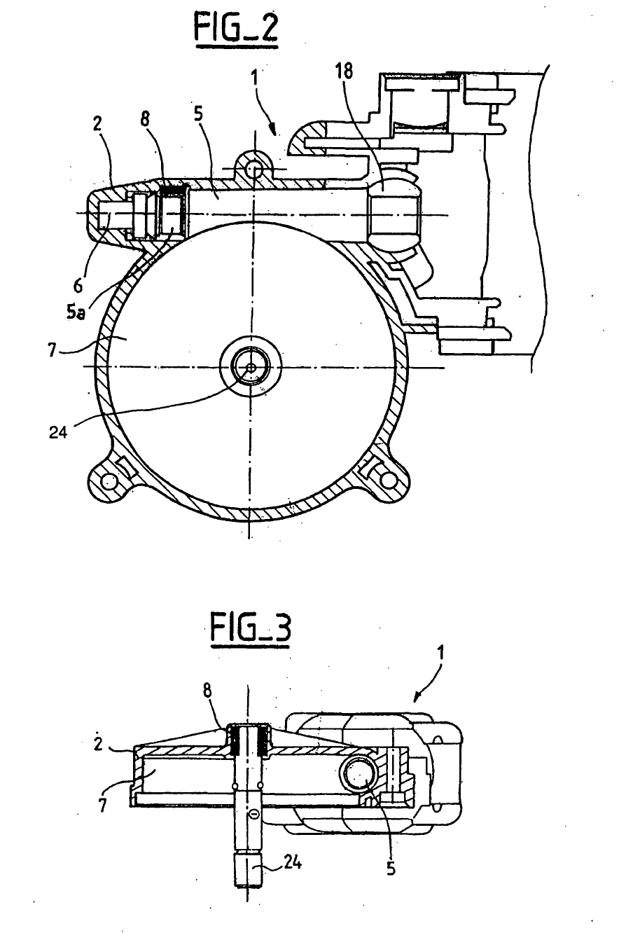

FIG. 2 shows a top view of an alternate geared motor assembly 1. In this figure, the bearing 19 is not depicted. According to this embodiment, the sensor 8 is positioned at the end 5a of the drive shaft 5 in the housing 2. This location is particularly advantageous for the connecting of the sensor 8 to the sensor state processing circuit via the housing 2. It should be appreciated that the electric motor 3 and the damper 4 would be included in this embodiment, although they are not illustrated.

FIG. 3 shows a front view of another alternate geared motor assembly 1. The reduction gearset 7 is rotationally driven by the drive shaft 5 about a reduction shaft 24. The reduction shaft 24 is guided with respect to the housing 2 by a bearing (not depicted). The sensor 8 is arranged on the bearing and detects the force of separation of the sets of teeth.

The sensor 8 can also be used to detect when the window has reached the upper or lower end of its travel in the door. Detection is done in the same way as in the case of an obstacle impeding the movement of the window.

It is also possible to provide a plurality of sensors 8, improving the quality with which blockage of the reduction gearset 7 is detected.

It is possible, for example, to use a piezoresistive sensor that is known per se and available commercially. The electrical impedance of the sensor 8 increases in proportion to the load applied to its two faces. It is also possible to use a sensor 8 exhibiting a capacitance, an inductance, or more generally an impedance, the value of which varies as a function of the load applied to the sensor 8. Such a sensor 8 is compact and has terminals ready for connecting. The response time of the sensors 8 is preferably shorter than 25 ms.

The invention also relates to a window lifter including a geared motor assembly 1 as described. The geared motor assembly 1 allows the window lifter to interrupt its operation when the window is at the top or bottom end of its travel, or when an obstacle impedes the operation of the window. Interruption avoids trapping the obstacle, such as a hand, and protects the geared motor assembly 1.

Of course, the present invention is not restricted to the embodiments described by way of example. Thus, the sensor 8 or sensors may be employed independently of the damper 4. Furthermore, the geared motor assembly 1 described may be the one used to operate a sunroof. It may also be used to move a car seat. The invention is particularly advantageous when the leg of a rear-seat passenger impedes the sliding of the seat. Nor is the invention limited to a housing surrounding the entirety of the geared motor assembly 1.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A window lifter geared motor assembly comprising: a housing;
an electric motor in said housing; and
a damper damping movements of said electric motor in said housing.

2. The geared motor assembly according to claim 1, wherein said geared motor assembly further comprises a drive shaft driven in rotation about an axis by said electric motor, said electric motor and said drive shaft being able to move in said housing along said axis, and said damper damping movements of said electric motor and said drive shaft along said axis.

3. The geared motor assembly according to claim 2, wherein said damper damps movements of said electric motor in one direction along said axis.

4. The geared motor assembly according to claim 2, wherein said damper is a spring located between said housing and said electric motor.

5. The geared motor assembly according to claim 2, wherein said damper damps movements of said electric motor in a first direction along said axis and in a second direction along said axis opposite to said first direction.

6. The geared motor assembly according to claim 5, wherein said damper includes two tension-compression springs located between said housing and said electric motor, one of said springs being located on opposed sides of said electric motor along said axis.

7. The geared motor assembly according to claim 2, wherein said geared motor assembly further comprises a sensor, with a state of said sensor being dependent upon movements of said electric motor and of said drive shaft along said axis.

8. The geared motor assembly according to claim 7, wherein said drive shaft is guided with respect to said housing by a bearing, and said sensor is located on said bearing.

9. The geared motor assembly according to claim 7, further including a reduction gearset driven in rotation about a reduction shaft, said shaft being guided with respect to said housing by a bearing, and said sensor is located on said bearing.

10. The geared motor assembly according to claim 7, wherein said sensor is fixed with respect to said housing.

11. The geared motor assembly according to claim 7, wherein driving of said drive shaft is dependent upon a state of said sensor.

12. A method of damping movements in a window lifter geared motor assembly comprising the steps of:
providing an electric motor in a housing; and
damping movements of said electric motor in said housing.

13. The method as recited in claim 12 further including the steps of rotationally driving a drive shaft by said electric motor about an axis and moving said electric motor and said drive shaft along said axis, and the step of damping includes damping movements of said electric motor and said drive shaft along said axis.

14. The method as recited in claim 13 wherein the step of damping damps movements of said electric motor and said drive shaft in one direction along said axis.

15. The method as recited in claim 13 wherein the step of damping damps movements of said electric motor and said drive shaft in a first direction along said axis and in a second direction along said axis opposite to said first direction.

16. The method as recited in claim 13 further including the step of sensing the step of moving said electric motor and said drive shaft along said axis.
